(19) United States
(12) Patent Application Publication
(10) Pub. No.: US 2026/0147370 A1
(43) Pub. Date: May 28, 2026

(54) CURRENT MIRROR CIRCUIT AND IMAGING DEVICE

(71) Applicant: SONY SEMICONDUCTOR SOLUTIONS CORPORATION, KANAGAWA (JP)

(72) Inventors: MASAYUKI MORIMUNE, KANAGAWA (JP); YUKEN YAKUSHIJI, KANAGAWA (JP)

(21) Appl. No.: 19/122,764

(22) PCT Filed: Sep. 11, 2023
(86) PCT No.: PCT/JP2023/033014

§ 371 Date: Apr. 21, 2025

(30) Foreign Application Priority Data
Oct. 28, 2022 (JP) 2022-172836

(51) Int. Cl. G05F 3/26; H04N 25/78

(52) U.S. Cl. CPC G05F 3/262; H04N 25/78

(57) ABSTRACT

Provided is a current mirror circuit capable of adjusting the noise characteristic of the entire circuit while adjusting output impedance. The current mirror circuit includes a signal line that is connected to a plurality of circuits, a first current source, a first transistor, a second current source, a second transistor, and an adjustment mechanism. The first transistor is gate-connected to the signal line. The first current source is connected to a drain of the first transistor. The second transistor is gate-connected to the first current source and includes a source connected to the signal line. The second current source is connected to the signal line. The adjustment mechanism adjusts output impedance applied to the signal line.

### TECHNICAL FIELD

The technology according to the present disclosure (present technology) relates to a current mirror circuit and an imaging device including the current mirror circuit.

### BACKGROUND ART

In an imaging device, a pixel signal read from a pixel has been typically converted from an analog signal into a digital signal by a column analog-digital converter, and subjected to signal processing by a digital signal processor (DSP). For the column analog-digital converter, a current mirror circuit has been used.

The current mirror circuit includes a reference current source that supplies a driving current, and supplies the current supplied from the reference current source to the column analog-digital converter (for example, Patent Document 1).

Incidentally, the column analog-digital converter includes a plurality of circuits for converting a pixel signal from an analog signal to a digital signal for each pixel. In a case where a current is sent to the plurality of circuits by the current mirror circuit, there is a case where it is desired to lower and adjust the output impedance on the transmission side, which is the side of the plurality of circuits.

CITATION LIST

### Patent Document

Patent Document 1: Japanese Patent Application Laid-Open No. 2009-21685

### SUMMARY OF THE INVENTION

### Problems to be Solved by the Invention

However, in the current mirror circuit described in Patent Document 1, output impedance cannot be adjusted.

The present disclosure has been made in view of such circumstances, and an object thereof is to provide a current mirror circuit and an imaging device capable of adjusting the noise characteristic of the entire circuit while adjusting output impedance.

### Solutions to Problems

An aspect of the present disclosure is a current mirror circuit including: a signal line that is connected to a plurality of circuits; a first transistor that is gate-connected to the signal line; a first current source that is connected to a drain of the first transistor; a second transistor that is gate-connected to the first current source and includes a source connected to the signal line; a second current source that is connected to the signal line; and an adjustment mechanism that adjusts output impedance applied to the signal line.

Another aspect of the present disclosure is an imaging device including a current mirror circuit including: a signal line that is connected to a plurality of circuits; a first transistor that is gate-connected to the signal line; a first current source that is connected to a drain of the first transistor; a second transistor that is gate-connected to the first current source and includes a source connected to the signal line; a second current source that is connected to the signal line; and an adjustment mechanism that adjusts output impedance applied to the signal line.

### BRIEF DESCRIPTION OF DRAWINGS

FIG. 1 is a block diagram illustrating an example of the schematic configuration of an imaging device according to a first embodiment of the present disclosure.

FIG. 2 is a block diagram for explaining an example of an image signal reading mechanism in the imaging device according to the first embodiment of the present disclosure.

FIG. 3 is a circuit diagram for explaining an example of a current mirror circuit according to a first comparative example of the first embodiment.

FIG. 4 is a circuit diagram for explaining an example of a current mirror circuit according to a second comparative example of the first embodiment.

FIG. 5 is a circuit diagram for explaining an example of a current mirror circuit according to the first embodiment of the present disclosure.

FIG. 6 is a circuit diagram for explaining an example of a current mirror circuit according to a second embodiment of the present disclosure.

FIG. 7 is a circuit diagram for explaining an example of a current mirror circuit according to a third embodiment of the present disclosure.

FIG. 8 is a circuit diagram for explaining an example of a current mirror circuit according to a fourth embodiment of the present disclosure.

FIG. 9 is a circuit diagram for explaining an example of a current mirror circuit according to a fifth embodiment of the present disclosure.

FIG. 10 is a circuit diagram for explaining an example of a current mirror circuit according to a sixth embodiment of the present disclosure.

FIG. 11 is a block diagram illustrating a configuration example of an imaging system as an electronic apparatus to which the present technology is applied.

### MODE FOR CARRYING OUT THE INVENTION

Hereinafter, embodiments of the present disclosure will be described with reference to the drawings. In the description of the drawings referred to in the following description, the same or similar parts are denoted by the same or similar reference signs to avoid the description from being redundant.

Note that the effects described in the present specification are merely examples and are not limited, and other effects may be provided.

### First Embodiment

### Overall Configuration of Imaging Device

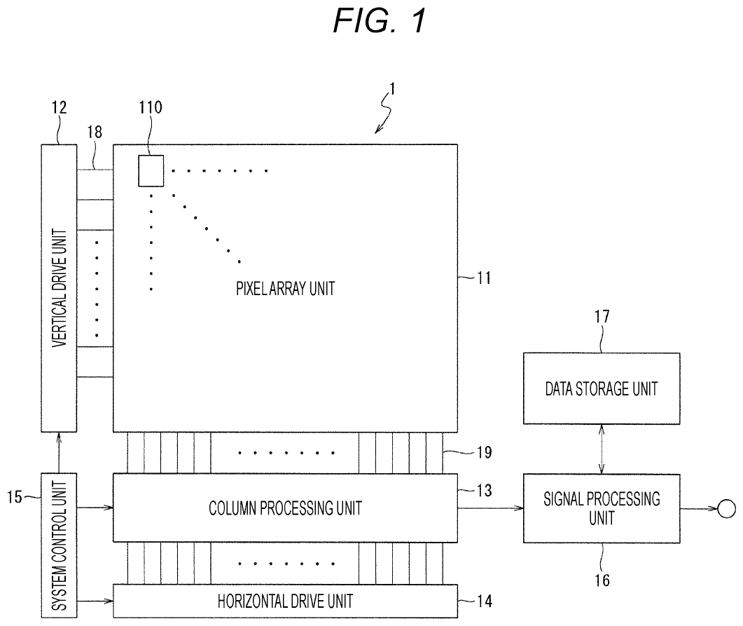

FIG. 1 is a block diagram illustrating an example of the schematic configuration of an imaging device according to a first embodiment of the present disclosure. An imaging device 1 is a semiconductor device that converts a charge amount corresponding to the intensity of light formed as an image on each pixel into an electric signal, using a photoelectric conversion element such as a photodiode constituting each pixel, and outputs the electric signal as image data, and is configured as, for example, a CMOS image sensor. The imaging device 1 can be integrally configured as, for example, a system on a chip (SoC) such as a CMOS LSI, but for example, some components described below may be configured as separate LSIs.

As illustrated in the figure, the imaging device 1 includes, for example, components such as a pixel array unit 11, a vertical drive unit 12, a column processing unit 13, a horizontal drive unit 14, a system control unit 15, a signal processing unit 16, and a data storage unit 17.

The pixel array unit 11 includes a photoelectric conversion element group such as photodiodes forming pixels 110 arrayed in a horizontal direction (row direction) and a vertical direction (column direction). The pixel array unit 11 converts a charge amount corresponding to the intensity of incident light formed as an image on each pixel 110 into an electric signal and outputs the electric signal as a pixel signal.

The vertical drive unit 12 includes a shift register, an address decoder, and the like. The vertical drive unit 12 supplies a drive signal and the like to each pixel 110 via a plurality of pixel drive lines 18, thereby driving each pixel 110 of the pixel array unit 11, for example, simultaneously or row by row.

The column processing unit 13 reads a pixel signal from each pixel via a vertical signal line (VSL) 19 for each pixel column of the pixel array unit 11, and performs noise removal processing, correlated double sampling (CDS) processing, analog-to-digital (A/D) conversion processing, and the like. The pixel signal processed by the column processing unit 13 is output to the signal processing unit 16.

The horizontal drive unit 14 includes a shift register, an address decoder, and the like. The horizontal drive unit 14 sequentially selects the pixels 110 corresponding to the pixel columns of the column processing unit 13. When selective scanning is thus performed by the horizontal drive unit 14, the pixel signals subjected to the signal processing for each pixel 110 in the column processing unit 13 are sequentially output to the signal processing unit 16.

The system control unit 15 includes a timing generator that generates various timing signals and the like. The system control unit 15 performs drive control of the vertical drive unit 12, the column processing unit 13, and the horizontal drive unit 14 on the basis of, for example, a timing signal generated by the timing generator (not depicted).

The signal processing unit 16 performs signal processing such as arithmetic processing or the like on the pixel signal supplied from the column processing unit 13 while temporarily storing data in the data storage unit 17 as necessary, and outputs an image signal based on each pixel signal.

Note that the imaging device 1 to which the present technology is applied is not limited to the above-described configuration. For example, the imaging device 1 may be configured such that the data storage unit 17 is disposed at a subsequent stage of the column processing unit 13, and the pixel signals output from the column processing unit 13 are supplied to the signal processing unit 16 via the data storage unit 17.

Alternatively, the imaging device 1 may be configured such that the column processing unit 13, the data storage unit 17, and the signal processing unit 16 connected in cascade process the respective pixel signals in parallel.

FIG. 2 is a block diagram for explaining an example of an image signal reading mechanism in the imaging device according to the first embodiment of the present disclosure. In the figure, a pixel signal reading mechanism 20 from one pixel 110 in two pixel columns is exemplarily illustrated.

The figure illustrates a current mirror circuit 30 and a comparator 131 that is used in an analog-digital converter (hereinafter, referred to as an AD converter) as the configuration of the column processing unit 13.

As illustrated in the figure, the pixel 110 includes a photoelectric conversion unit 1101, a transfer transistor 1102, a floating diffusion unit (hereinafter, referred to as an FD unit) 1103, an amplification transistor 1104, a selection transistor 1105, and a reset transistor 1106. In the present example, each transistor in the pixel 110 is an N-type metal-oxide-semiconductor (MOS) transistor (hereinafter, referred to as an NMOS transistor), but is not limited thereto.

Furthermore, a plurality of drive lines for supplying various drive signals TGL, RST, SEL, and the like to the pixel 110 is wired, for example, for each pixel row as the pixel drive lines 18 illustrated in FIG. 1. These drive signals are, for example, pulse signals that bring the NMOS transistor into a conductive (on) state at a high potential level and bring the NMOS transistor into a non-conductive (off) state at a low potential level.

The photoelectric conversion unit 1101 is, for example, a PN-junction photodiode. The photoelectric conversion unit 1101 generates and accumulates a charge corresponding to the amount of received light. The transfer transistor 1102 is an NMOS transistor provided between the photoelectric conversion unit 1101 and the FD unit 1103. The drive signal TGL is applied to a gate of the transfer transistor 1102. That is, when the drive signal TGL reaches a high potential level, the transfer transistor 1102 enters a conductive state, and the charge accumulated in the photoelectric conversion unit 1101 is transferred to the FD unit 1103 via the transfer transistor 1102.

The reset transistor 1106 is an NMOS transistor provided between a constant potential VDD and the FD unit 1103. The drive signal RST is applied to a gate of the reset transistor 1106. When the drive signal RST reaches a high potential level, the reset transistor 1106 enters a conductive state, and the potential of the FD unit 1103 is reset to a level of the constant potential VDD.

The FD unit 1103 is a floating diffusion region capable of holding a predetermined charge amount. The charge accumulated in the FD unit 1103 is subjected to charge-voltage conversion into a voltage signal by the amplification transistor 1104 and read out.

The amplification transistor 1104 is an NMOS transistor having a gate connected to the FD unit 1103 and a drain connected to the constant potential VDD. The amplification transistor 1104 serves as an input unit of a reading circuit for reading the charge held in the FD unit 1103, that is, a source follower circuit. That is, the amplification transistor 1104 a source of which is connected to a vertical signal line 19 through the selection transistor 1105 forms the source follower circuit together with a current source 191 connected to the vertical signal line 19.

The selection transistor 1105 is an NMOS transistor provided between the source of the amplification transistor 1104 and the vertical signal line 19. The drive signal SEL is applied to a gate of the selection transistor 1105. When the drive signal SEL reaches a high potential level, the selection transistor 1105 enters a conductive state, and the pixel 110 enters a selected state. As a result, the pixel signal output from the amplification transistor 1104 is read out to the vertical signal line 19 via the selection transistor 1105.

### Configuration of Comparator

In contrast, the comparator 131 are provided in parallel for the respective vertical signal lines 19 corresponding to the pixel columns. The comparator 131 is a differential amplifier including a first input unit 1311, a second input unit 1312, and a third input unit 1313. The first input unit 1311, the second input unit 1312, and the third input unit 1313 are NMOS transistors. The first input unit 1311 has a gate connected to the vertical signal line 19 and a source connected to a source of the second input unit 1312 and a drain of the third input unit 1313. A pixel signal is applied to the gate of the first input unit 1311. That is, when the voltage of the pixel signal exceeds a threshold voltage between the gate and a drain of the first input unit 1311, the first input unit 1311 enters a conductive state, and the pixel signal is output from the drain of the first input unit 1311.

The second input unit 1312 has a gate connected to a reference signal circuit (not illustrated) and the source connected to the source of the first input unit 1311 and the drain of the third input unit 1313. A reference signal is applied to the gate of the second input unit 1312. That is, when the voltage of the reference signal exceeds a threshold voltage between the gate and the drain of the second input unit 1312, the second input unit 1312 enters a conductive state, and the reference signal is output from the drain of the second input unit 1312.

The third input unit 1313 has a gate connected to a signal line 31 of the current mirror circuit 30, a source grounded, and the drain connected to the source of the first input unit 1311 and the source of the second input unit 1312. The comparator 131 operates when a driving current is supplied from the current mirror circuit 30. Then, a current signal is applied from the current mirror circuit 30 to the gate of the third input unit 1313. When the voltage of the current signal exceeds a threshold voltage between the gate and the drain of the third input unit 1313, the third input unit 1313 enters a conductive state, and the current signal is output from the drain of the third input unit 1313.

The comparator 131 compares the pixel signal with the reference signal, and outputs a signal according to the comparison result to a counter (not illustrated). The counter performs counting on the input signal according to a predetermined clock, and outputs the counted value as a pixel signal in a digital format.

### Comparative Examples of Embodiment

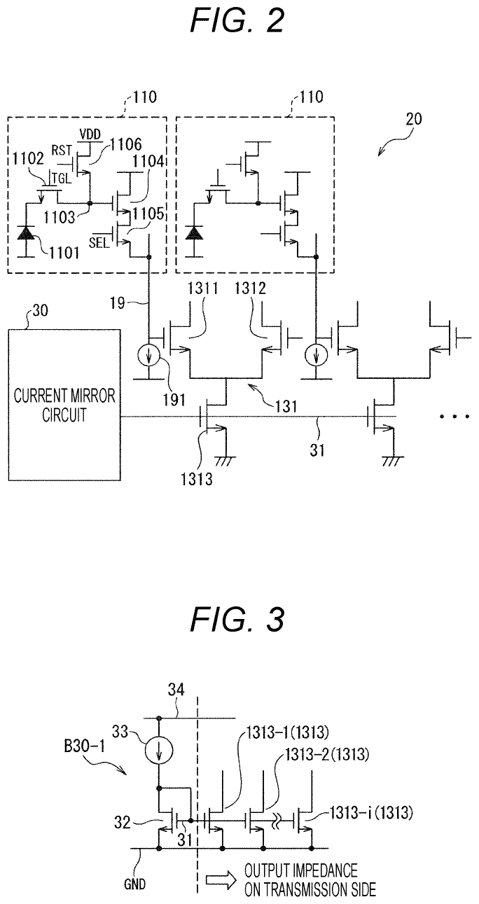

FIG. 3 is a circuit diagram for explaining an example of a current mirror circuit according to a first comparative example of the first embodiment. In the figure, a current mirror circuit B30-1 includes a first transistor 32 and a first current source 33. In the present example, the first transistor 32 is an NMOS transistor, but the present invention is not limited thereto. A signal line 31 is connected to a gate of the first transistor 32. A source of the first transistor 32 is connected to a ground potential GND. The first current source 33 is provided between a drain of the first transistor 32 and a power supply line 34 (constant potential VDD). The first current source 33 is connected to the drain of the first transistor 32 and is directly connected to the signal line 31.

The current from the first current source 33 is converted into a voltage signal by the first transistor 32, and is output to a plurality of third input units 1313-1 to 1313-i (i is an integer) via the signal line 31.

Incidentally, in a case where the voltage signal is sent to the plurality of third input units 1313-1 to 1313-i by the current mirror circuit B30-1, the output impedance on the transmission side increases.

Therefore, a current mirror circuit that lowers the output impedance has been proposed.

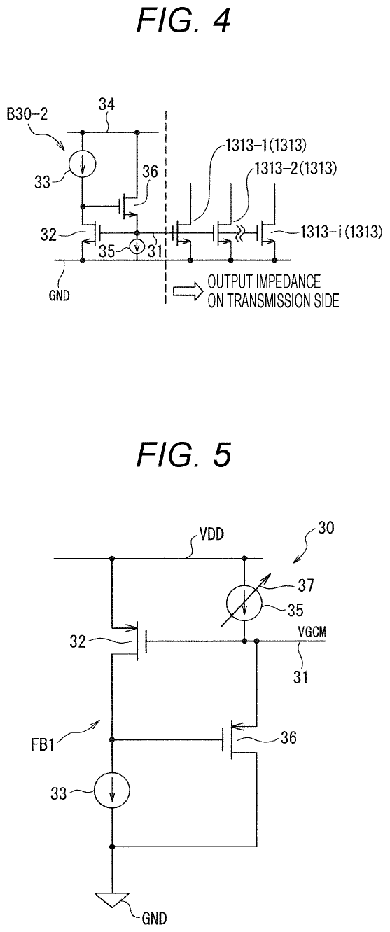

FIG. 4 is a circuit diagram for explaining an example of a current mirror circuit according to a second comparative example of the first embodiment. In FIG. 4, the same parts as those in FIG. 3 described above are denoted by the same reference signs, and detailed description thereof is omitted.

A current mirror circuit B30-2 further includes a second current source 35 and a second transistor 36. In the present example, the second transistor 36 is an NMOS transistor, but the present invention is not limited thereto.

The second transistor 36 is gate-connected to a first current source 33, and has a source connected to a signal line 31 and a drain connected to a power supply line 34 (constant potential VDD). The second current source 35 is provided between the signal line 31 and a ground potential GND. The second transistor 36 amplifies the potential applied to a gate of a first transistor 32 according to the current value output from the first current source 33. Then, when the potential applied to the gate of the first transistor 32 exceeds the threshold voltage between the gate and a source of the first transistor 32, the first transistor 32 enters a conductive state, the current output from the first current source 33 is converted into a voltage signal by the first transistor 32, and the voltage signal is supplied to a plurality of third input units 1313-1 to 1313-i via the signal line 31.

Incidentally, according to the current mirror circuit B30-2, the output impedance on the transmission side can be lowered, but the output impedance cannot be adjusted in a case where the output impedance is excessively lowered.

### Solving Means of First Embodiment

Therefore, in the first embodiment of the present disclosure, the current mirror circuit 30 includes an impedance adjustment mechanism that adjusts the output impedance applied to the signal line 31 by adjusting the loop gain band of a feedback loop FB1 formed by the first transistor 32, the signal line 31, and the second transistor 36.

FIG. 5 is a circuit diagram for explaining an example of the current mirror circuit 30 according to the first embodiment of the present disclosure. In FIG. 5, the same parts as those in FIG. 4 described above are denoted by the same reference signs, and detailed description thereof is omitted.

In the first embodiment of the present disclosure, a current adjuster 37 that adjusts the current flowing from a second current source 35 to the signal line (VGCM) 31 is provided as the impedance adjustment mechanism. That is, in the first embodiment of the present disclosure, the band of the source follower configured by the second transistor 36 and the second current source 35 is changed using the current adjuster 37, and the loop gain band of the feedback loop FB1 is adjusted.

In the first embodiment of the present disclosure, a source of a first transistor 32 is connected to the constant potential VDD. A first current source 33 is provided between a drain of the first transistor 32 and the ground potential GND. A drain of the second transistor 36 is connected to the ground potential GND. The second current source 35 is provided between the signal line 31 and the constant potential VDD.

The current output from the first current source 33 is converted into a voltage signal by the first transistor 32 and the second transistor 36, and is output to a plurality of third input units 1313-1 to 1313-i via the signal line 31. An error signal (noise) propagated from the circuits driven by the plurality of third input units 1313-1 to 1313-i via the signal line 31 is superimposed on the voltage signal output to the source of the second transistor 36. The error signal (noise) is output to the drain of the first transistor 32 in a reverse phase, is superimposed on the signal line 31 through the second transistor 36, and tries to cancel the noise propagated to the signal line 31.

In order to adjust the degree of cancellation, the band of the source follower configured by the second transistor 36 and the second current source 35 is changed using the current adjuster 37, and for example, the current adjuster 37 is adjusted in a direction in which the current decreases, so that the band of the feedback loop FB1 configured by the first transistor 32 and the second transistor 36 is narrowed, and the effect of canceling the noise is weakened.

### Effects Produced by First Embodiment

As described above, according to the first embodiment, the loop gain band of the feedback loop FB1 formed by the first transistor 32, the signal line 31, and the second transistor 36 can be adjusted by the current adjuster 37, so that the output impedance can be adjusted at a low level, whereby the noise characteristic of the entire circuit can be adjusted.

### Second Embodiment

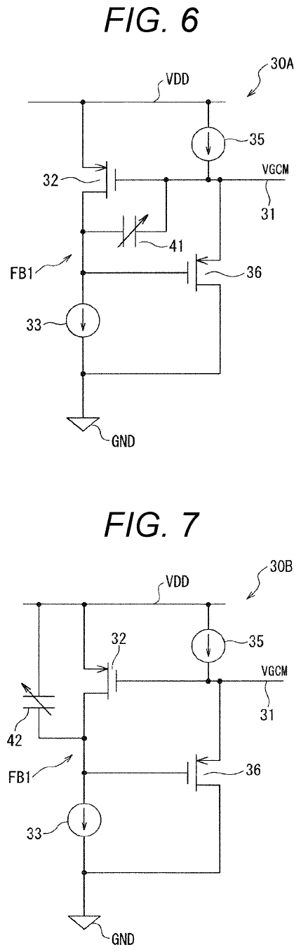

FIG. 6 is a circuit diagram for explaining an example of a current mirror circuit 30A according to a second embodiment of the present disclosure. In FIG. 6, the same parts as those in FIG. 5 described above are denoted by the same reference signs, and detailed description thereof is omitted.

In the second embodiment of the present disclosure, a variable capacitance capacitor 41 is connected between a signal line 31 and a drain of a first transistor 32 to form a low-pass filter in a feedback loop FB1. Then, the capacitance ratio of the capacitor 41 is adjusted to adjust the loop gain band of the feedback loop FB1.

An error signal (noise) sent from a plurality of third input units 1313-1 to 1313-i via the signal line 31 passes between a source and a gate of a second transistor 36 and is attenuated by the low-pass filter.

### Effects Produced by Second Embodiment

As described above, according to the second embodiment, by connecting the variable capacitance capacitor 41 between the signal line 31 and the drain of the first transistor 32 to form the low-pass filter, the loop gain band of the feedback loop FB1 can be narrowed, and the effect of canceling the error signal (noise) propagated from the plurality of third input units 1313-1 to 1313-i via the signal line 31 can be weakened. Furthermore, by adjusting the capacitance ratio of the capacitor 41, the output impedance on the transmission side can be adjusted, and thereby the noise characteristic of the entire circuit can be adjusted.

### Third Embodiment

FIG. 7 is a circuit diagram for explaining an example of a current mirror circuit 30B according to a third embodiment of the present disclosure. In FIG. 7, the same parts as those in above FIG. 5 are denoted by the same reference signs, and a detailed description thereof is omitted.

In the third embodiment of the present disclosure, a variable capacitance capacitor 42 is connected between a drain of a first transistor 32 and a constant potential VDD to form a low-pass filter in a feedback loop FB1. Then, the capacitance ratio of the capacitor 42 is adjusted to adjust the loop gain band of the feedback loop FB1.

An error signal (noise) sent from a plurality of third input units 1313-1 to 1313-i via the signal line 31 passes between a source and a gate of a second transistor 36 and is attenuated by the low-pass filter.

### Effects Produced by Third Embodiment

As described above, according to the third embodiment, by connecting the capacitor 42 between the drain of the first transistor 32 and the constant potential VDD to form the low-pass filter, the loop gain band of the feedback loop FB1 can be narrowed, and the effect of canceling the error signal (noise) propagated from the plurality of third input units 1313-1 to 1313-i via the signal line 31 can be weakened. Furthermore, by adjusting the capacitance ratio of the capacitor 42, the output impedance on the transmission side can be adjusted, and thereby the noise characteristic of the entire circuit can be adjusted.

### Fourth Embodiment

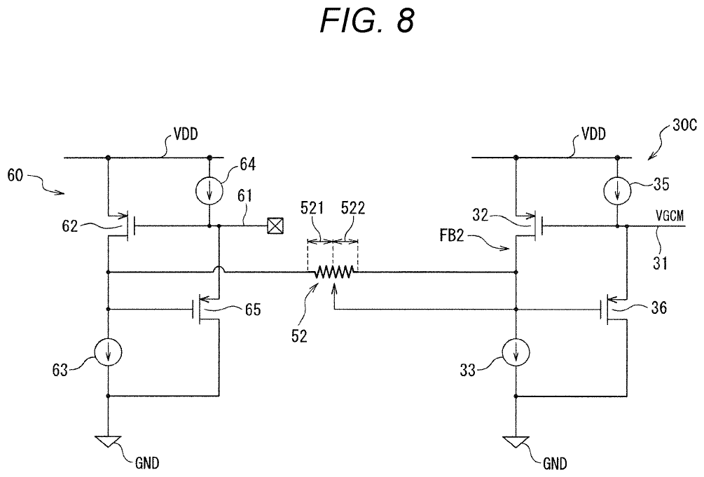

FIG. 8 is a circuit diagram for explaining an example of a current mirror circuit 30C according to a fourth embodiment of the present disclosure. In FIG. 8, the same parts as those in above FIG. 5 are denoted by the same reference signs, and a detailed description thereof is omitted.

In the fourth embodiment of the present disclosure, one end of a resistor 52 is connected to a drain of a first transistor 32. The other end of the resistor 52 is connected to a replica circuit 60 which includes the same components as those of the current mirror circuit 30C. The resistor 52 is divided into two resistors 521 and 522 by a signal line extending from a gate of a second transistor 36. The resistance values of the respective resistors 521 and 522 for voltage division can be adjusted.

The replica circuit 60 includes a signal line 61, a first transistor 62, a first current source 63, a second current source 64, and a second transistor 65. The signal line 61 is connected to a gate of the first transistor 62. A source of the first transistor 62 is connected to a constant potential VDD. The first current source 63 is provided between a drain of the first transistor 62 and a ground potential GND. Note that, unlike a signal line 31, a plurality of third input units 1313-1 to 1313-i is not connected to the signal line 61.

The second transistor 65 is gate-connected to the first current source 63, and has a source connected to the signal line 61 and a drain connected to the ground potential GND. The second current source 64 is provided between the signal line 61 and the constant potential VDD. The other end of the resistor 52 is connected to the drain of the first transistor 62.

In the fourth embodiment of the present disclosure, a feedback loop FB2 is formed by the first transistor 32, the signal line 31, the second transistor 36, and the resistor 522. An error signal (noise) sent from the plurality of third input units 1313-1 to 1313-i via the signal line 31 passes between a source and the gate of the second transistor 36 and is output to the resistor 522. Furthermore, a low frequency (direct current) voltage fluctuation (power supply noise) generated at the constant potential VDD passes between the source and the gate of the second transistor 36 and is output to the resistor 522.

Then, with reference to the bias voltage output from the replica circuit 60, the error signal (noise) and the power supply noise are divided by the resistor 52 and output to the drain of the first transistor 32. As a result, the error signal (noise) and the power supply noise are attenuated. Moreover, by adjusting the resistance values of the respective resistors 521 and 522 for voltage division, the output impedance on the transmission side can be adjusted, whereby the noise characteristic of the entire circuit can be adjusted.

### Effects Produced by Fourth Embodiment

As described above, according to the fourth embodiment, the output impedance can be adjusted by dividing, by the resistor 52, the error signal (noise) output to the feedback loop FB2 from the plurality of third input units 1313-1 to 1313-i with reference to the bias voltage output from the replica circuit 60, and furthermore, the fourth embodiment is resistant to power supply noise.

Note that, in the fourth embodiment, the bias voltage output from the replica circuit 60 is used as a reference, but a reference signal other than the bias voltage output from the replica circuit 60 may be used as a reference.

### Fifth Embodiment

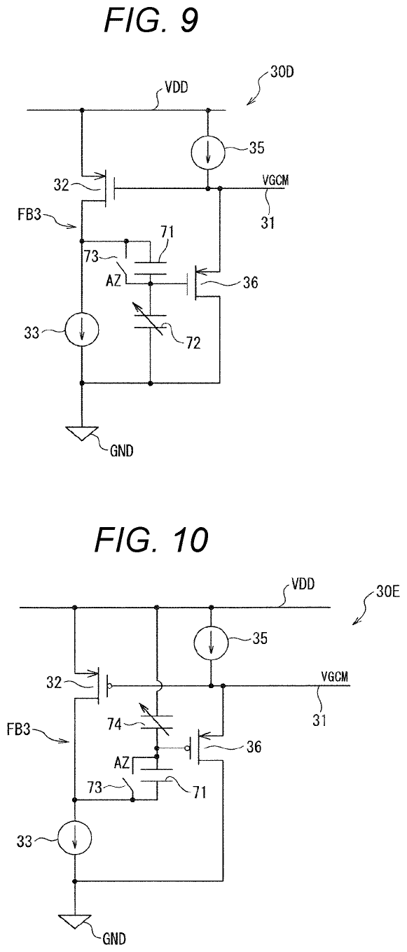

FIG. 9 is a circuit diagram for explaining an example of a current mirror circuit 30D according to a fifth embodiment of the present disclosure. In FIG. 9, the same parts as those in FIG. 5 described above are denoted by the same reference signs, and detailed description thereof is omitted.

The fifth embodiment of the present disclosure includes a first capacitor 71, a variable capacitance second capacitor 72, and an auto zero (AZ) switch 73. The first capacitor 71 is connected between a first current source 33 and a drain of a first transistor 32, and a gate of a second transistor 36. The second capacitor 72 is connected between a ground potential GND and the gate of the second transistor 36. The AZ switch 73 is connected in parallel to the first capacitor 71 to switch on and off of a short circuit.

In the fifth embodiment of the present disclosure, a feedback loop FB3 is formed by the first transistor 32, a signal line 31, the second transistor 36, and the first capacitor 71.

During auto zero operation, the AZ switch 73 is switched to the ON state to short-circuit the first capacitor 71. Then, a voltage signal sent to a plurality of third input units 1313-1 to 1313-i passes between a source and the gate of the second transistor 36 and is fed back to the first transistor 32.

At the time of driving, the AZ switch 73 is switched to the OFF state. Then, the voltage signal sent to the plurality of third input units 1313-1 to 1313-i and an error signal (noise) sent from the plurality of third input units 1313-1 to 1313-i via the signal line 31 pass between the source and the gate of the second transistor 36 and are accumulated in the first capacitor 71. Furthermore, power supply noise generated at a constant potential VDD passes between the source and the gate of the second transistor 36 and is accumulated in the first capacitor 71.

Then, the error signal (noise) and the power supply noise of the power supply voltage are divided by the first capacitor 71 and the second capacitor 72 and output to a drain of the first transistor 32. As a result, the error signal (noise) and the power supply noise of the power supply voltage are attenuated. Moreover, by adjusting the capacitance ratio of the second capacitor 72, the output impedance on the transmission side can be adjusted, whereby the noise characteristic of the entire circuit can be adjusted.

### Effects Produced by Fifth Embodiment

As described above, according to the fifth embodiment, the output impedance can be adjusted by dividing, by the first capacitor 71 and the second capacitor 72, the error signal sent from the plurality of third input units 1313-1 to 1313-i via the signal line 31.

### Sixth Embodiment

FIG. 10 is a circuit diagram for explaining an example of a current mirror circuit 30E according to a sixth embodiment of the present disclosure. In FIG. 10, the same parts as those in the above-described FIG. 9 are denoted by the same reference signs, and detailed description thereof is omitted.

In the sixth embodiment of the present disclosure, a second capacitor 74 is connected between a gate of a second transistor 36 and a constant potential VDD. In the present example, a first transistor 32 and the second transistor 36 are P-type MOS transistors (PMOS transistors) having a polarity opposite to that of an NMOS transistor.

During auto zero operation, the AZ switch 73 is switched to the ON state to short-circuit the first capacitor 71. Then, a voltage signal sent to a plurality of third input units 1313-1 to 1313-i passes between a source and the gate of the second transistor 36 and is fed back to the first transistor 32.

At the time of driving, the AZ switch 73 is switched to the OFF state. Then, the voltage signal sent to the plurality of third input units 1313-1 to 1313-i and an error signal (noise) sent from the plurality of third input units 1313-1 to 1313-i via the signal line 31 pass between the source and the gate of the second transistor 36 and are accumulated in the first capacitor 71. Furthermore, power supply noise generated at a constant potential VDD passes between the source and the gate of the second transistor 36 and is accumulated in the first capacitor 71.

Then, the error signal (noise) and the power supply noise are divided by the first capacitor 71 and the second capacitor 74 and output to a drain of the first transistor 32. As a result, the error signal (noise) and the power supply noise are attenuated. Moreover, by adjusting the capacitance ratio of the second capacitor 74, the output impedance on the transmission side can be adjusted, whereby the noise characteristic of the entire circuit can be adjusted.

### Effects Produced by Sixth Embodiment

As described above, the sixth embodiment produces effects similar to the effects produced by the fifth embodiment described above, and furthermore, has higher power supply noise resistance.

### Other Embodiments

The present technology has been described as above according to the first to sixth embodiments, but it should not be understood that the description and drawings forming a part of this disclosure limit the present technology. It will be apparent to those skilled in the art that various alternative embodiments, examples, and operation techniques can be included in the present technology when understanding the spirit of the technical content disclosed in the first to sixth embodiments described above. Furthermore, the configurations disclosed in the first to sixth embodiments can be appropriately combined within a range in which no contradiction occurs. For example, configurations disclosed in a plurality of different embodiments may be combined, or configurations disclosed in a plurality of different modifications of the same embodiment may be combined.

### Application Example to Electronic Apparatus

The photodetection device described above can be applied to various electronic apparatuses such as, for example, an imaging device such as a digital still camera and a digital video camera, a mobile phone with an imaging function, or other apparatuses having an imaging function.

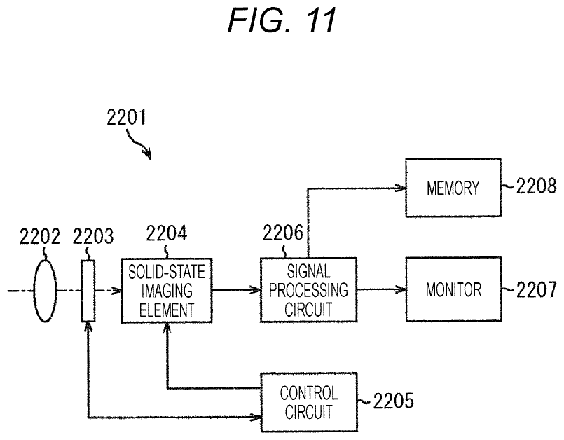

FIG. 11 is a block diagram illustrating a configuration example of an imaging system as an electronic apparatus to which the present technology is applied.

An imaging system 2201 illustrated in FIG. 11 includes an optical system 2202, a shutter device 2203, a solid-state imaging element 2204 as an imaging device, a control circuit 2205, a signal processing circuit 2206, a monitor 2207, and two memories 2208, and can capture a still image and a moving image.

The optical system 2202 includes one or a plurality of lenses, and guides light from a subject (incident light) to the solid-state imaging element 2204 to form an image on a light receiving surface of the solid-state imaging element 2204.

The shutter device 2203 is arranged between the optical system 2202 and the solid-state imaging element 2204 and controls a light irradiation period and a light shielding period for the solid-state imaging element 2204 under the control of the control circuit 2205.

The solid-state imaging element 2204 includes a package including the solid-state imaging element described above. The solid-state imaging element 2204 accumulates a signal charge for a certain period according to the light the image of which is formed on the light receiving surface via the optical system 2202 and the shutter device 2203. The signal charges accumulated in the solid-state imaging element 2204 are transferred according to a drive signal (timing signal) supplied from the control circuit 2205.

The control circuit 2205 outputs the drive signal to control a transfer operation of the solid-state imaging element 2204 and a shutter operation of the shutter device 2203 to drive the solid-state imaging element 2204 and the shutter device 2203.

The signal processing circuit 2206 performs various types of signal processing on the signal charges output from the solid-state imaging element 2204. An image (image data) obtained by the signal processing circuit 2206 performing the signal processing is supplied to the monitor 2207 to be displayed or supplied to the memory 2208 to be stored (recorded).

Also in the imaging system 2201 configured as described above, the imaging device 1 can be applied instead of the solid-state imaging element 2204 described above.

Note that the present disclosure can also have the following configurations.

(1)

A current mirror circuit including:
a signal line that is connected to a plurality of circuits;
a first transistor that is gate-connected to the signal line;
a first current source that is connected to a drain of the first transistor;
a second transistor that is gate-connected to the first current source and includes a source connected to the signal line;
a second current source that is connected to the signal line; and
an adjustment mechanism that adjusts output impedance applied to the signal line.

(2)

The current mirror circuit according to (1), in which the adjustment mechanism adjusts the output impedance by adjusting a current flowing from the first current source to the signal line.

(3)

The current mirror circuit according to (1), in which the adjustment mechanism includes a capacitor that is connected between the signal line and the drain of the first transistor, and adjusts the output impedance by adjusting a capacitance ratio of the capacitor.

(4)

The current mirror circuit according to (1), in which the adjustment mechanism includes a capacitor that is connected between the drain of the first transistor and a power supply potential, and adjusts the output impedance by adjusting a capacitance ratio of the capacitor.

(5)

The current mirror circuit according to (1), in which the adjustment mechanism includes a resistor having one end connected to the drain of the first transistor, and adjusts the output impedance by dividing, by the resistor, an error signal propagated from the plurality of circuits via the signal line with reference to a signal input to another end of the resistor.

(6)

The current mirror circuit according to (5) further including:
a replica circuit including same components as the first current source, the first transistor, the second current source, and the second transistor,
in which the replica circuit is connected to the another end of the resistor, and
the adjustment mechanism adjusts the output impedance by dividing, by the resistor, an error signal propagated from the plurality of circuits via the signal line with reference to a bias voltage output from the replica circuit.

(7)

The current mirror circuit according to (1), in which the adjustment mechanism includes a first capacitor that is connected between the first current source and a gate of the second transistor, and a second capacitor that is connected between the gate of the second transistor and a power supply potential, and adjusts the output impedance by dividing, by the first capacitor and the second capacitor, an error signal propagated from the plurality of circuits via the signal line.

(8)

The current mirror circuit according to (7), in which the second capacitor is of a variable capacitance type.

(9)

The current mirror circuit according to (7), further including a switch unit that is connected in parallel to the first capacitor and switches on and off of a short circuit.

(10)

The current mirror circuit according to (1), in which the adjustment mechanism includes a first capacitor that is connected between the first current source and a gate of the second transistor, and a second capacitor that is connected between the gate of the second transistor and a ground potential, and adjusts the output impedance by dividing, by the first capacitor and the second capacitor, an error signal propagated from the plurality of circuits via the signal line.

(11)

The current mirror circuit according to (10), in which the second capacitor is of a variable capacitance type.

(12)

The current mirror circuit according to (10), further including a switch unit that is connected in parallel to the first capacitor and switches on and off of a short circuit.

(13)

An imaging device including a current mirror circuit including:
a signal line that is connected to a plurality of circuits;
a first transistor that is gate-connected to the signal line;
a first current source that is connected to a drain of the first transistor;
a second transistor that is gate-connected to the first current source and includes a source connected to the signal line;
a second current source that is connected to the signal line; and
an adjustment mechanism that adjusts output impedance applied to the signal line.

### REFERENCE SIGNS LIST

1 Imaging device
11 Pixel array unit
12 Vertical drive unit
13 Column processing unit
14 Horizontal drive unit
15 System control unit
16 Signal processing unit
17 Data storage unit
18 Pixel drive line
19 Vertical signal line
20 Pixel signal reading mechanism
30, 30A, 30B, 30C, 30D, 30E Current mirror circuit
31, 61 Signal line
32, 62 First transistor
33, 63 First current source
34 Power supply line
35, 64 Second current source
36, 65 Second transistor
37 Current adjuster
41, 42 Capacitor
52 Resistor
60 Replica circuit
71 First capacitor
72, 74 Second capacitor
73 Auto zero (AZ) switch
110 Pixel
131 Comparator
191 Current source
521, 522 Resistor
1101 Photoelectric conversion unit
1102 Transfer transistor
1103 FD unit
1104 Amplification transistor
1105 Selection transistor
1106 Reset transistor
1311 First input unit
1312 Second input unit
1313 (1313-1 to 1313-i) Third input unit
2201 Imaging system
2202 Optical system
2203 Shutter device
2204 Solid-state imaging element
2205 Control circuit
2206 Signal processing circuit
2207 Monitor
2208 Memory
FB1, FB2, FB3 Feedback loop
VDD Constant potential
GND Ground potential

1. A current mirror circuit comprising:
a signal line that is connected to a plurality of circuits;
a first transistor that is gate-connected to the signal line;
a first current source that is connected to a drain of the first transistor;
a second transistor that is gate-connected to the first current source and includes a source connected to the signal line;
a second current source that is connected to the signal line; and
an adjustment mechanism that adjusts output impedance applied to the signal line.

2. The current mirror circuit according to claim 1, wherein the adjustment mechanism adjusts the output impedance by adjusting a current flowing from the second current source to the signal line.

3. The current mirror circuit according to claim 1, wherein the adjustment mechanism includes a capacitor that is connected between the signal line and the drain of the first transistor, and adjusts the output impedance by adjusting a capacitance ratio of the capacitor.

4. The current mirror circuit according to claim 1, wherein the adjustment mechanism includes a capacitor that is connected between the drain of the first transistor and a power supply potential, and adjusts the output impedance by adjusting a capacitance ratio of the capacitor.

5. The current mirror circuit according to claim 1, wherein the adjustment mechanism includes a resistor having one end connected to the drain of the first transistor, and adjusts the output impedance by dividing, by the resistor, an error signal propagated from the plurality of circuits via the signal line with reference to a signal input to another end of the resistor.

6. The current mirror circuit according to claim 5 further comprising:
a replica circuit including same components as the first current source, the first transistor, the second current source, and the second transistor,
wherein the replica circuit is connected to the another end of the resistor, and
the adjustment mechanism adjusts the output impedance by dividing, by the resistor, an error signal propagated from the plurality of circuits via the signal line with reference to a bias voltage output from the replica circuit.

7. The current mirror circuit according to claim 1, wherein the adjustment mechanism includes a first capacitor that is connected between the first current source and a gate of the second transistor, and a second capacitor that is connected between the gate of the second transistor and a power supply potential, and adjusts the output impedance by dividing, by the first capacitor and the second capacitor, an error signal propagated from the plurality of circuits via the signal line.

8. The current mirror circuit according to claim 7, wherein the second capacitor is of a variable capacitance type.

9. The current mirror circuit according to claim 7, further comprising a switch unit that is connected in parallel to the first capacitor and switches on and off of a short circuit.

10. The current mirror circuit according to claim 1, wherein the adjustment mechanism includes a first capacitor that is connected between the first current source and a gate of the second transistor, and a second capacitor that is connected between the gate of the second transistor and a ground potential, and adjusts the output impedance by dividing, by the first capacitor and the second capacitor, an error signal propagated from the plurality of circuits via the signal line.

11. The current mirror circuit according to claim 10, wherein the second capacitor is of a variable capacitance type.

12. The current mirror circuit according to claim 10, further comprising a switch unit that is connected in parallel to the first capacitor and switches on and off of a short circuit.

13. An imaging device comprising a current mirror circuit including:
a signal line that is connected to a plurality of circuits;
a first transistor that is gate-connected to the signal line;
a first current source that is connected to a drain of the first transistor;
a second transistor that is gate-connected to the first current source and includes a source connected to the signal line;
a second current source that is connected to the signal line; and
an adjustment mechanism that adjusts output impedance applied to the signal line.
